(19) United States
(12) Patent Application Publication
(10) Pub. No.: US 2016/0314772 A1
(43) Pub. Date: Oct. 27, 2016

(54) EFFECT PEDAL

(71) Applicant: Aalberg Audio AS, Trondheim (NO)

(72) Inventor: Rune Aalberg Alstad, Trondheim (NO)

(21) Appl. No.: 15/100,580

(22) PCT Filed: Dec. 16, 2014
(86) PCT No.: PCT/NO2014/050236

§ 371 Date: May 31, 2016

(30) Foreign Application Priority Data
Dec. 17, 2013 (NO) 20131691

(51) Int. Cl. G10H 1/34; G10H 1/00

(52) U.S. Cl. CPC G10H 1/344; G10H 1/0091; G10H 2210/155; G10H 2220/321; G10H 2240/211

(57) ABSTRACT

A system for handling effect pedals is provided. The present invention is achieved by a remote control unit operable by a guitarist. The system comprises a remote control unit used by a guitarist and at least one effect pedal wherein the at least one effect pedal is controllable from said remote control unit.

### BACKGROUND OF THE INVENTION

1. Technical Field

The invention relates to effect pedals in general and more specifically a system and a method for handling effect pedals for guitars.

2. Background Art

From prior art one should refer to effect pedals, unit placed on the floor before a guitarist for adding and adjusting effects applied to the guitar. These have pedals, switches activated by foot, as well as knobs for adjustment.

From prior art one should refer to US 2013/0058507 disclosing a system and method wherein a smart phone controls an audio system wherein the transmission is wireless using an acoustic signal from the smart phone to a microphone or a guitar. A direct connection to an effect pedal is not disclosed.

One should also refer to US 2013/0177176 disclosing a switch that switched an effect pedal in or out preferably using relays. Change of parameters for effect pedals is not disclosed.

Also one should further refer to GB 2472022 disclosing a mixer that can switch effects in our out yet does not control effect pedals.

Finally one should refer to US 2013/0312588 disclosing a virtual effect pedal.

### DISCLOSURE OF THE INVENTION

### Problems to be Solved by the Invention

As guitarists often use a large suite of effect pedals the adjustments become cumbersome and time consuming when the intention is rather to perform before an audience. This also means that the guitarist is constrained to a position near the effect pedals, especially when making changes, and must also bend down to make these changes.

Therefore, a main objective of the present invention is to provide a system and method for easy handling of more than one effect pedal.

### Means for Solving the Problems

The objective is achieved according to the invention by a remote control of an effect pedal as defined in the preamble of claim 1, having the features of the characterising portion of claim 1.

A number of non-exhaustive embodiments, variants or alternatives of the invention are defined by the dependent claims.

The present invention attains the above-described objective by a remote control unit operable by a guitarist. The system comprises a remote control unit used by a guitarist and at least one effect pedal wherein the at least one effect pedal is controllable from said remote control unit

In a preferred embodiment the remote control unit is attachable to a guitar, a guitar strap or a belt.

In a preferred embodiment the remote control operates the at least one effect pedal using wireless communication. In alternative embodiments the remote control uses ultrasonic or infrared means for communication.

### Effects of the Invention

The technical difference over traditional effect pedals is that the guitarist is now able to control more than one effect pedals from the remote control. Moreover the guitarist is no longer constrained to the area immediately near the effect pedals but can move more freely.

These effects provide in turn several further advantageous effects:
it makes it possible to change the effect pedals at any time
it no longer is necessary to bend down to adjust effect pedals, which traditionally are placed on the floor

### BRIEF DESCRIPTION OF THE DRAWINGS

The above and further features of the invention are set forth with particularity in the appended claims and together with advantages thereof will become clearer from consideration of the following detailed description of an exemplary embodiment of the invention given with reference to the accompanying drawings.

The invention will be further described below in connection with exemplary embodiments which are schematically shown in the drawings, wherein:

FIG. 1 shows a wireless effect pedal

FIG. 2 shows a wireless control unit in detail

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The invention will be further described in connection with exemplary embodiments which are schematically shown in the drawings.

### Principles Forming the Basis of the Invention

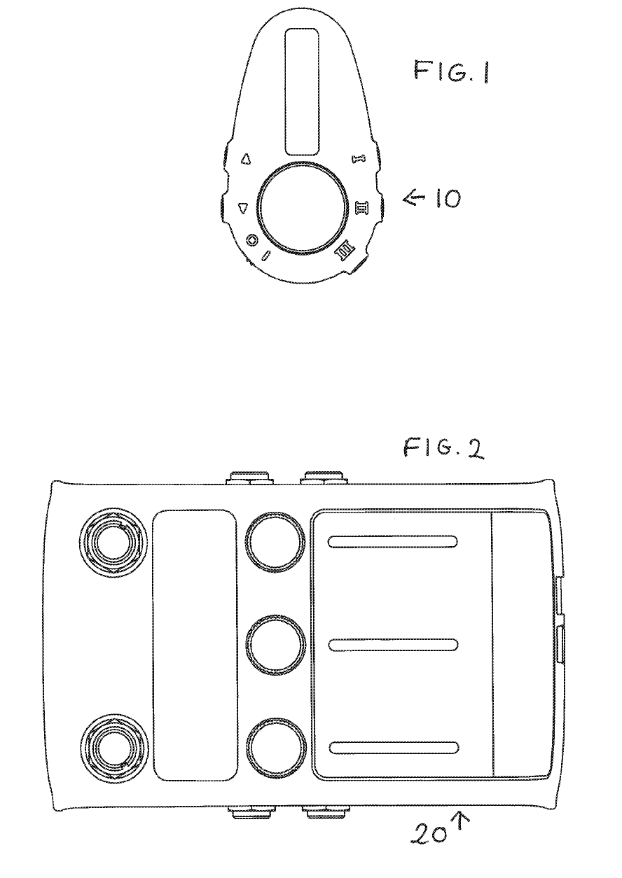

FIG. 1 and FIG. 2 shows a wireless control unit 10 and a corresponding wireless effect pedal 20 respectively. The remote control unit 10 is attached to the guitar, guitar strap or a belt, and is therefore quickly and easily reachable for the guitarist.

### BEST MODES OF CARRYING OUT THE INVENTION

In one embodiment of the apparatus according to the invention, a wireless control unit 10 is attached to a guitar close to the strings for easy reach, and effect pedals 20 on a floor. FIG. 1 shows the remote control 10 in detail with an easy to read dial and buttons for control. In one embodiment of the invention, the remote control comprises different control functions, wherein: effect parameter knob, tap tempo button, press buttons, prey/next buttons, wireless communication, etc. An effect parameter knob placed on the wireless guitar control unit 10, is also a combined button for tap tempo. Tapping this button twice, sets the speed/tempo for the time-based effects parameters, such as the spacing between two echoes for the delay effect. Preset buttons allows the user to store different presetting's of effect combinations, and recall those anytime during a performance wirelessly from the guitar. The communication between the wireless control unit 10 and the guitar effect pedal 20 is wirelessly with ultrasonic communication or infrared communication.

FIG. 2 shows an effect pedal 20 for placing on the floor and having a readout display, readable for the guitarist without having to bend down. In one embodiment of the invention, the effect pedal 20 comprises different control functions, wherein: prey/next footswitch (FX-select), effect parameter knobs, on/off footswitch, etc. A switch allows the user to select which one of the different effect parameters on the guitar effect pedal 20 is active (lit) for controlling from the effect parameter knob on the wireless guitar control unit 10.

The system preferably comprises one remote control 10 for the guitarist and more than one remote controlled effect pedals 20. This can be connected to existing conventional equipment such as amplifiers and external analogue and digital effect units.

It is preferable that the system or the remote control 10 is configurable to adjust more than one effect pedal 20 simultaneously.

### ALTERNATIVE EMBODIMENTS

A number of variations on the above can be envisaged. For instance the system can also comprise a unit for visual feedback such as a tablet. This can be used both to inform the guitarist of current status as well as to control the system. This can beneficially be unobtrusively attached to existing equipment such as a microphone stand.

In a preferred embodiment this unit is a tablet or a smartphone running an app. In a more preferred embodiment the unit communicates with the rest of the system using wireless communication.

In addition to the configuration wherein one remote control unit 10 is operable to control a plurality of effect pedals 20, one can also envisage configurations wherein a plurality of remote controls 10 are operable to control one or more effect pedals 20. In a system wherein at least one effect pedal 20 can be controlled by more than one remote control unit 10 it can be beneficial to ensure a system wherein the effect pedal 20 is locked to one remote control 10 for the duration of adjustment. One can also envisage feedback such as tactile feedback from the system via the remote control unit 10 to the guitarist.

### INDUSTRIAL APPLICABILITY

The invention according to the application finds use for guitarists when performing in front of an audience and also when in a studio.

1. A system for handling effect pedals (20) comprising a remote control unit (10) operable by a guitarist wherein the remote control unit (10) is provided with means for setting at least one parameter for an effect pedal (20),
characterised in that the remote control unit (10) is local to the guitarist and that the effect pedal (20) wherein the at least one effect pedal (20) is controllable from said remote control unit.

2. The system according to claim 1, wherein the remote control unit (10) is provided with means for selecting one of a plurality of effect pedals (20).

3. The system according to claim 1, wherein the remote control unit (10) is provided with means for attachment to at least one of a guitar, a guitar strap and a belt.

4. The system according to claim 1, wherein the remote control unit (10) operates the at least one effect pedal (20) using at least one means from the group comprising wireless communication, ultrasonic communication and infrared communication.

5. The system according to claim 4, wherein the remote control unit (10) operates the more than one effect pedal (20).

6. The system according to claim 5, wherein the remote control unit (10) is configurable to adjust more than one effect pedal (20) simultaneously.

7. An effect pedal (20) for use with the system according to claim 1, wherein the effect pedal (20) is operable to be controlled by a remote control unit (10).

8. The effect pedal (20) according to claim 7, wherein the effect pedal (20) is further operable to be controlled by more than one remote control unit (10).

9. The effect pedal (20) according to claim 8, wherein the effect pedal (20) is selectable operable to be controlled in the following modes:
a first mode wherein the effect pedal (20) is controllable by one remote control unit (10), and
a second mode wherein the effect pedal (20) is controllable by more than one remote control unit (10).
